(19) United States
(12) Patent Application Publication
(10) Pub. No.: US 2025/0012058 A1
(43) Pub. Date: Jan. 9, 2025

(54) AN ATMOSPHERIC WATER GENERATING DEVICE AND A METHOD OF ACTIVE OR ADAPTIVE ATMOSPHERIC WATER GENERATION

(71) Applicant: ROYAL SCIENTIFIC SOCIETY, Amman (JO)

(72) Inventors: Kyle E. CORDOVA, Amman (JO); Husam ALMASSAD, Amman (JO)

(73) Assignee: ROYAL SCIENTIFIC SOCIETY, Amman (JO)

(21) Appl. No.: 18/292,700

(22) PCT Filed: Jul. 20, 2022
(86) PCT No.: PCT/JO2022/050012

§ 371 Date: Jan. 26, 2024

Related U.S. Application Data
(60) Provisional application No. 63/225,567, filed on Jul. 26, 2021.

(51) Int. Cl. E03B 3/28; B01D 5/00; B01D 46/00; B01D 53/04; B01D 53/26; C02F 1/00; C02F 1/68

(52) U.S. Cl. CPC E03B 3/28; B01D 5/0003; B01D 5/0051; B01D 46/0028; B01D 53/0438; B01D 53/0446; B01D 53/0454; B01D 53/261; B01D 53/265; C02F 1/001; C02F 1/008; C02F 1/68; B01D 2253/204; B01D 2257/80; B01D 2258/06; B01D 2259/40088; B01D 2279/65

(57) ABSTRACT

An atmospheric water generator device and a method of adaptive atmospheric water harvesting may include an air processing compartment having a heating member, a water adsorption/desorption compartment having a plurality of water adsorption beds configured to receive an air flow; a condensation compartment having a condenser; a water collection compartment; a controlling unit having a plurality of sensors configured to sense climate conditions, and a controller; and a power generation and storage unit configured to provide the air processing compartment, the water adsorption/desorption compartment, the condensation compartment, the water collection compartment, and the controlling unit with the required electrical energy to operate. The heating member in the air processing compartment is configured to heat the air flow passing through the water adsorption/desorption compartment. A method of generating water may use the atmospheric water generator device.

### CROSS-REFERENCE TO EARLIER FILED APPLICATION

The present application claims priority from the U.S. provisional patent application No. 63/225,567 dated Jul. 26, 2021, which is incorporated herein by reference.

### TECHNICAL FIELD

The present disclosure generally relates to water generating devices, methods and techniques and more particularly to atmospheric water generating devices, methods and techniques that are based on reversible adsorption and desorption processes using active and adaptive modes of operation.

### BACKGROUND INFORMATION

Atmospheric water generating devices and methods are suitable for humid, arid, urban and/or remote areas where access to clean water supply is limited. Various attempts have been conducted in the art to develop water collecting and/or atmospheric water generating devices.

For instance, the Australian patent application published under number AU2020103193 discloses an apparatus, method, and a system for collecting atmospheric water using a desiccant material configured to absorb water vapor in incident air. In such apparatus, system, and method, the desiccant material is heated leading to the evaporation of the absorbed water vapor, which is then condensed using a condenser.

The Canadian patent application published under number CA3022487 discloses a hybrid atmospheric water generator that utilizes a water generating unit and a preconditioning unit configured to increase humidity of air prior to water condensation. The water generating unit has a condensing unit with a water condensing heat exchanger coupled to source of cooling. The preconditioning unit includes a heat exchanger and an absorption unit having a desiccant, such as silica gel, configured to store moisture for release when air is passed through or near the absorption unit. The heat exchanger is used to increase the temperature of air moving into or through the preconditioning unit in order to increase the amount of moisture the air is able to store.

The international patent application published under number WO2020095327 discloses an atmospheric water generator capable of selectively producing three different types of water, namely potable, alkaline, and de-mineralized water. The generator includes a vapor compression refrigeration unit for condensation of atmospheric moisture involving a vapor condensation unit including forced suction of atmospheric moist air involving fan means ducted to evaporator, the evaporator is maintained below dew point temperature by circulation of refrigerant. The moist air on contact with cold surface of evaporator loses heat and condenses into water droplets, wherein the collection of water droplets may be achieved by a tray.

The United States patent application published under number US2020332498 discloses a system for generating liquid water, the system includes a thermal desiccant unit having a porous hygroscopic material located within a housing, the housing has a fluid inlet and a fluid outlet, a working fluid that accumulates heat and water vapor upon flowing from fluid inlet of the housing, through the porous hygroscopic material, and to the fluid outlet of the housing, a condenser having a fluid inlet and a fluid outlet for condensing water vapor from the working fluid, an enthalpy exchange unit operatively coupled between the thermal desiccant unit and the condenser, wherein the enthalpy exchange unit transfers enthalpy between the working fluid output from the thermal desiccant unit and the working fluid input to the thermal desiccant unit.

The conventional solutions for generating water from the atmosphere cited above depend on directly heating the desiccant or the moisture absorbent material to release the absorbed water vapor, but do not heat the incoming air to increase the device's capacity to produce the maximum amount of liquid water. Also, these conventional solutions require a separate disinfection stage, either physical or chemical, in order to purify the generated water. Additionally, these conventional solutions work with continuous fixed cycles without considering the fluctuations of the climate conditions daily, monthly and seasonally.

### SUMMARY

Therefore, it is an object of the present disclosure to provide an atmospheric water generator that heats ambient air before entering the device, thus maximizing the device's capacity to produce liquid water.

It is another object of the present disclosure to provide an atmospheric water generator that has an adaptive and continuous operation cycle that taking into account the climate fluctuations, that will increase the efficiency and the performance of the atmospheric water generator.

It is yet another object of the present disclosure to provide an atmospheric water generator that produces pure liquid water without the need of having a separate water disinfection stage.

It is another object of the present disclosure to provide a device that combines high water vapor adsorption and desorption efficiency with a high production rate of liquid water.

It is another object of the present disclosure to provide a device with a long performance lifetime.

It is rather another object of the present disclosure to provide a method of generating liquid water from air using an atmospheric water generator device operating in an adaptive mode of operation.

It is rather another object of the present disclosure to provide a method of generating liquid water from air for use in dehumidification, water de-contamination, water desalination, personal water collection and use, use in military, cleaning, chemical and petrochemical industries, farming, irrigation, agriculture, greenhouses, biological control (mold and bacteria prevention), water purification, coolant for equipment and/or machines, temperature control and reduction, air conditioning or heating, among others.

It is yet another object of the present disclosure to provide a method of generating liquid water from air based on an adaptive and continuous operation cycle.

In aspects of the present disclosure, there is provided an atmospheric water generator that includes an air processing compartment having a heating member, a water adsorption/desorption compartment having a plurality of water adsorption beds configured to receive an air flow; a condensation compartment having a condenser; a water collection compartment; a controlling unit having a plurality of sensors configured to sense climate conditions, and a controller; and a power generation and storage unit configured to provide the air processing compartment, the water adsorption/desorption compartment, the condensation compartment, the water collection compartment and the controlling unit with the required electrical energy to operate, wherein the heating member in the air processing compartment is configured to heat the air flow passing through the water adsorption/desorption compartment.

In some aspects, the air processing compartment further includes a fan configured to generate the air flow, and an air filter configured to remove microorganisms, and other solid particulates suspended in the air flow.

In some aspects, the plurality of water adsorption beds is configured to include one or more water adsorbing materials.

In yet some aspects, the one or more water adsorbing materials is selected from a group comprising metal-organic frameworks, covalent organic frameworks, zeolitic imidazole frameworks, metal catecholates, metal azolates, zeolites, carbon, charcoal, porous rock, silica, porous polymers, porous organic polymers, microporous polymers, polymers, cross-linked polymers, salts, metal oxides, porous cages, clathrates, monoliths, organic molecules, slats, metals, metalloids, or combinations thereof.

In some aspects, the water adsorption/desorption compartment is lined with a thermally conductive material configured to transfer heat energy from the heating member to the plurality of adsorbent beds during a water desorption stage.

In some aspects, the condensation compartment further comprises a funnel configured to collect condensed water droplets over the condenser.

In aspects of the present disclosure, the condensation compartment further includes a vapor-compression refrigeration unit configured to cool down the condenser.

In some aspects, the vapor-compression refrigeration unit includes a temperature controller, an outdoor heat exchanging unit, and a compressor using a refrigerant to create a temperature gradient between an inside space of the condensation compartment and the outdoor heat exchanging unit.

In some aspects, the water collection compartment includes a water filtration and mineralization unit configured to purify condensed water droplets and add required minerals.

In some aspects of the present disclosure, the water filtration and mineralization unit include limestone, metal salt, charcoal, carbon, or any other fibrous material.

In some aspects, the water adsorption/desorption compartment and the condensation compartment are insulated using a suitable insulation material.

In aspects of the present disclosure, the controller is configured to control the operation of the fan, the heating member, the vapor-compression refrigeration unit, and water filtration and mineralization unit.

Other aspects of the present disclosure provide a method of generating atmospheric water using the device of any of the preceding claims in an active or adaptive mode of operation, the method comprises the steps of:
adsorbing, by the one or more adsorbent materials, water vapor contained in air flowing over the plurality of adsorbent material beds;
desorbing, once the one or more water adsorbent materials become saturated, the adsorbed water vapor;
condensing, by the condenser, the desorbed water vapor into water droplets; and
collecting the condensed water droplets by the funnel in the water collection compartment; In some aspects, the method further includes filtering, by the water filter, the collected water in the water collection compartment.

In yet some aspects, the method further includes adding minerals, by a mineralization unit, to the collected water in the water collection compartment.

In aspects of the present disclosure, adsorbing water vapor in an adaptive mode of operation includes the steps of:
sensing, by the plurality of sensors climate conditions;
determining, by the controller, the required time for adsorbing water vapor contained in humid air flow;
filtering, by the filter, the humid air flow; and
passing the humid filtered airflow over the plurality of adsorbent beds.

In aspects of the present disclosure, desorbing water vapor in an adaptive mode of operation comprises the steps of:
sensing, by the plurality of sensors climate conditions;
determining, by the controller, the required time for desorbing water vapor already adsorbed using the water adsorbent material;
heating, by the heating element, an ambient air flow after being filtered by the filter;
passing the heated filtered air flow over the one or more water adsorbent materials to desorb adsorbed water vapor; and
passing the heated filtered air flow which carries the desorbed water through a condensation compartment to condense the water vapor.

### BRIEF DESCRIPTION OF THE DRAWINGS

The present disclosure will now be described with reference to the accompanying drawings, without however limiting the scope thereto, and in which:

FIG. 1 illustrates a block diagram of an atmospheric water generator configured in accordance with one or more embodiments of the present disclosure.

FIG. 2A illustrates a schematic diagram of an atmospheric water generator configured in accordance with one or more embodiments of the present disclosure.

FIG. 2B illustrates a schematic diagram of another atmospheric water generator configured in accordance with one or more embodiments of the present disclosure.

FIG. 2C illustrates another schematic diagram showing the internal configuration of another atmospheric water generator shown in FIG. 2B, the atmospheric water generator being configured in accordance with one or more embodiments of the present disclosure.

FIG. 3A illustrates a schematic diagram of an air processing compartment of an atmospheric water generator configured in accordance with one or more embodiments of the present disclosure.

FIG. 3B illustrates a schematic diagram of another air processing compartment of an atmospheric water generator configured in accordance with one or more embodiments of the present disclosure.

FIG. 4 illustrates a schematic diagram of a water adsorption compartment of an atmospheric water generator configured in accordance with one or more embodiments of the present disclosure.

FIG. 5A illustrates a schematic diagram of a condensation compartment of an atmospheric water generator configured in accordance with one or more embodiments of the present disclosure.

FIG. 5B illustrates a schematic diagram of another condensation compartment of an atmospheric water generator configured in accordance with one or more embodiments of the present disclosure.

FIG. 6 illustrates a schematic diagram of an air filter of an atmospheric water generator configured in accordance with one or more embodiments of the present disclosure.

FIG. 7 illustrates a schematic diagram of a heating member of an atmospheric water generator configured in accordance with one or more embodiments of the present disclosure.

FIG. 8 illustrates a schematic diagram of a fan of an atmospheric water generator configured in accordance with one or more embodiments of the present disclosure.

FIG. 9 illustrates a schematic diagram of a condenser of an atmospheric water generator configured in accordance with one or more embodiments of the present disclosure.

FIG. 10A illustrates a schematic diagram of one of the plurality of adsorbent beds of an atmospheric water generator configured in accordance with one or more embodiments of the present disclosure.

FIG. 10B illustrates a schematic diagram of another adsorbent bed of an atmospheric water generator configured in accordance with one or more embodiments of the present disclosure.

FIG. 11 illustrates a schematic diagram of a funnel of an atmospheric water generator configured in accordance with one or more embodiments of the present disclosure.

FIG. 12 illustrates a method of generating atmospheric water configured in accordance with one or more embodiments of the present disclosure.

FIG. 13 illustrates a method of adsorbing atmospheric water vapor in the method of FIG. 12, the method being configured in accordance with embodiments of the present disclosure.

FIG. 14 illustrates a method of desorbing atmospheric water vapor in the method of FIG. 12, the methods being configured in accordance with embodiments of the present disclosure.

FIG. 15 illustrates a line graph showing the condensation compartment dew point response for the adsorption phase in a water harvesting cycle using the atmospheric water generation device configured according to embodiments of the present disclosure.

FIG. 16 illustrates a line graph showing water adsorption time as a function of humid air relative humidity using the atmospheric water generation device configured according to embodiments of the present disclosure.

FIG. 17 illustrates a line graph showing actual adsorption response at a condensation compartment after uploading water adsorption time formula into the device configured in accordance with embodiments of the present disclosure for a sample of climate conditions.

FIG. 18 illustrates a line graph showing the desorption phase dew point response as a function of relative heating time recorded in the condensation compartment for various climate conditions using the atmospheric water generation device configured according to embodiments of the present disclosure.

FIG. 19 illustrates a line graph showing water desorption time as a function of humid air relative humidity using the atmospheric water generation device configured according to embodiments of the present disclosure.

FIG. 20 illustrates a line graph showing actual desorption response at a condensation compartment after uploading water desorption time formula into the device configured in accordance with embodiments of the present disclosure for a sample of climate conditions.

### DETAILED DESCRIPTION

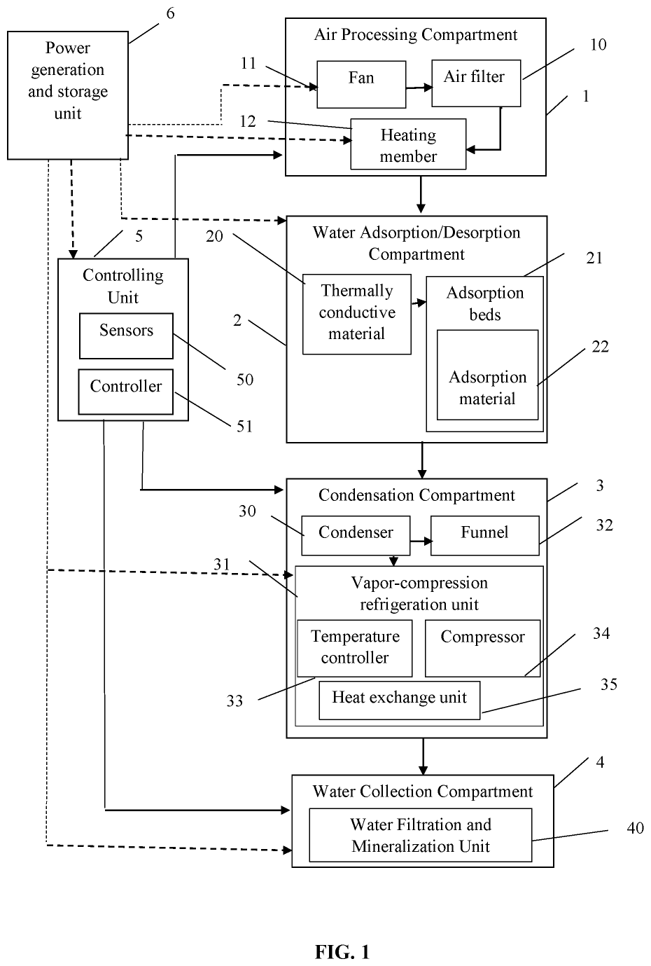

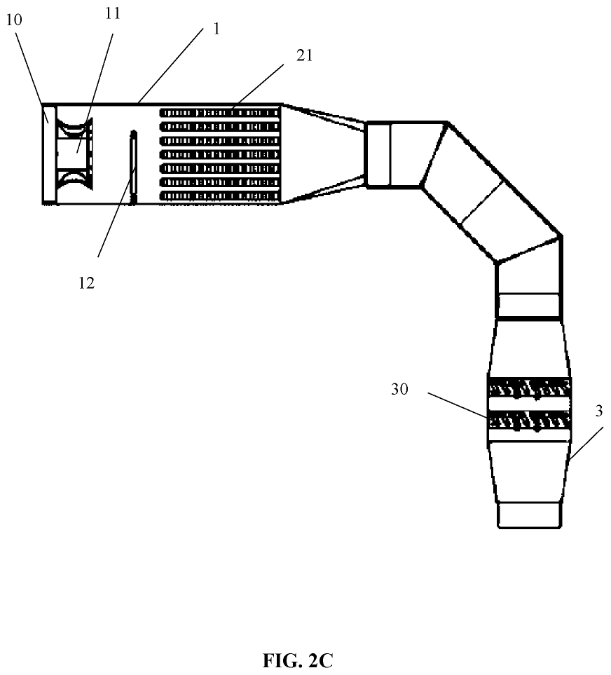

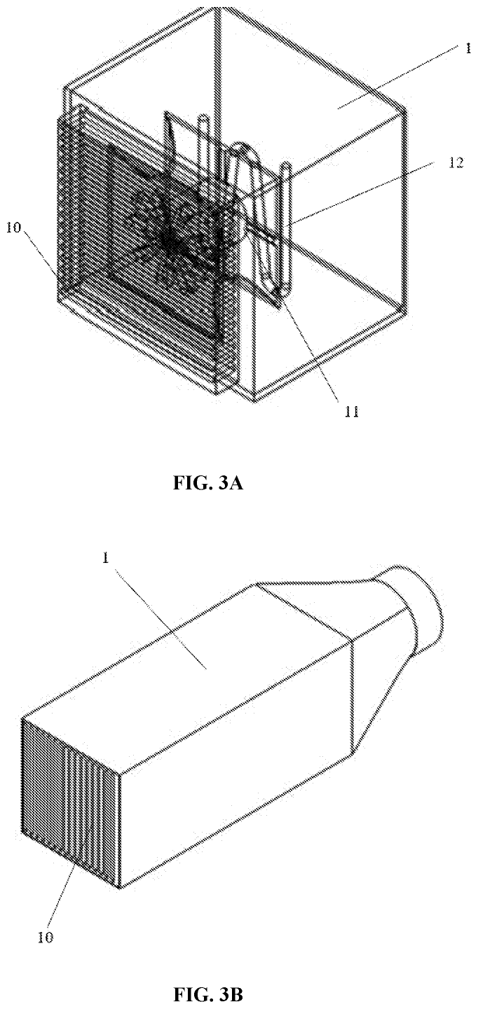

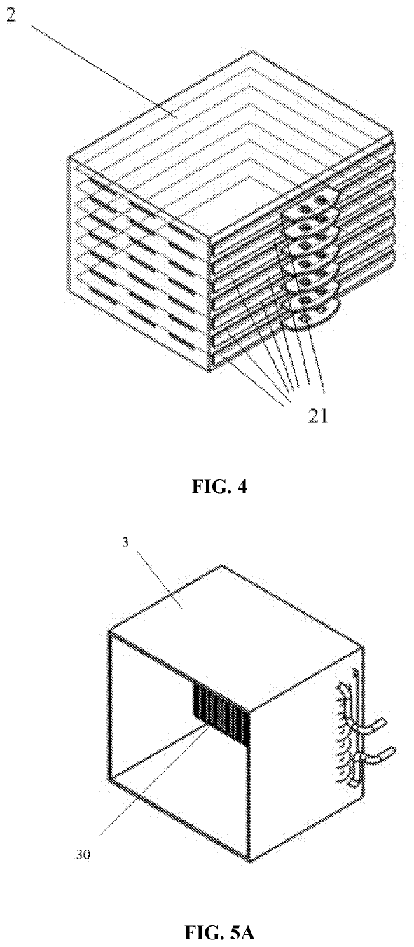

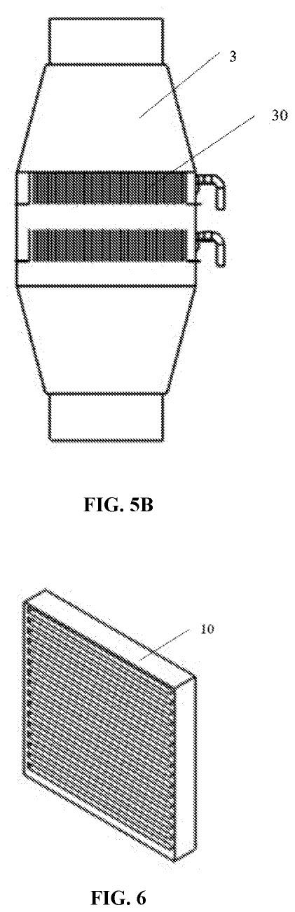

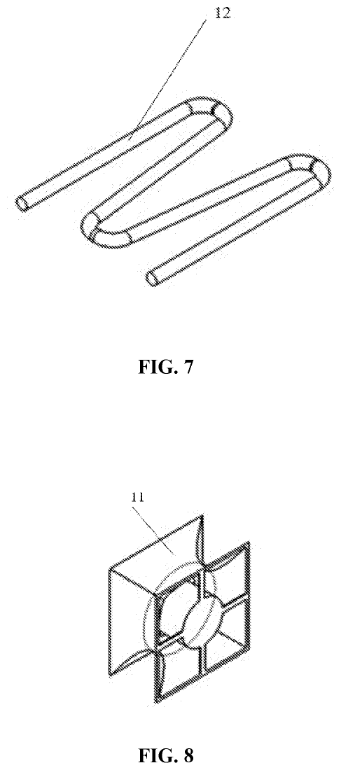

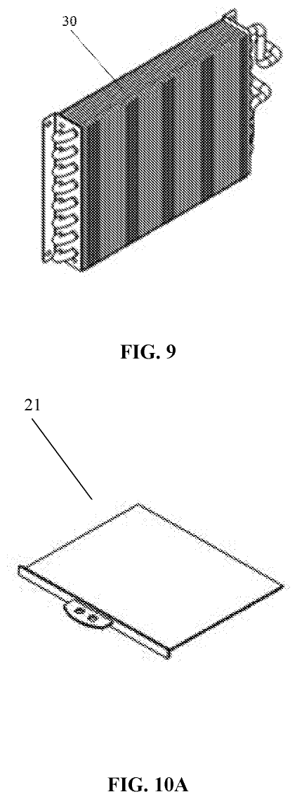

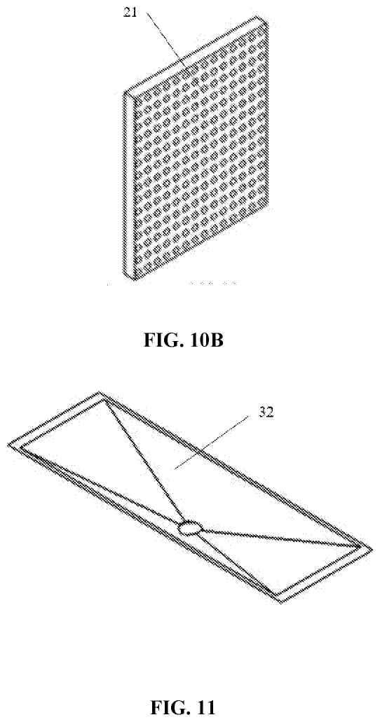

FIGS. 1-11 illustrate an atmospheric water generator device having an adaptive and continuous operation cycle configured in accordance with embodiments of the present disclosure. The atmospheric water generator device of the present disclosure may essentially include an air processing compartment 1, a water adsorption/desorption compartment 2, a condensation compartment 3, and a water collection compartment 4. In embodiments of the present disclosure, the air processing compartment 1, the water adsorption compartment 2, the condensation compartment 3, and the water collection compartment 4 may be operably connected to each other in series or in parallel.

In some embodiments, the air processing compartment 1 may be an indoor unit, while in other embodiments, the air processing compartment may be an outdoor unit connected to the water adsorption/desorption compartment 2 by means of ducts.

In embodiments of the present disclosure, the atmospheric water generator may further include a controlling unit 5 configured to control the operation of the device, and a power generation and storage unit 6 configured to provide the device with electric power needed for its operation. The power generation and storage unit 6 may comprise solar panels configured to convert solar energy into electrical energy and one or more batteries configured to store the generated electrical energy for later use.

In embodiments of the present disclosure, the air processing compartment 1 may be configured to capture and feed ambient air to the atmospheric water generator device of the present disclosure, and may include an air filter 10, wherein such air filter 10 may be made of a porous and/or fibrous material and may be configured to prevent solid particulates present in the ambient air from entering the atmospheric water generator device of the present disclosure. The solid particulates being prevented from entering the device of the present disclosure may include microorganisms, pollen, dust, and mold.

In some embodiments of the present disclosure, the air filter 10 may be a high efficiency particulate air (“HEPA”) filter.

In embodiments of the present disclosure, the air processing compartment 1 may further include a fan 11 configured to suck the ambient air and forces such air with a mutable air speed to pass through the air processing compartment 1, the water adsorption/desorption compartment 2, the condensation compartment 3, and the water collection compartment 4, respectively. The specifications of the fan 11 are dependent on the size and orientation of the device of the present disclosure, as well as the installation site. In some embodiments, the fan 11 may be of a high-speed, low-power type.

The air processing compartment 1 may further include a heating member 12 positioned in proximity to the fan 11, wherein such heating member 12 may be configured to raise the temperature of the air passing through the water adsorption/desorption compartment 2. The heating member 12 in embodiments of the present disclosure may be a coil made of a suitable material, such as, but not limited to, metal, metal alloy, ceramic, or composite material. In embodiments of the present disclosure, the temperature of air may be raised to less than 70° C.

The atmospheric water generating device of the present disclosure may operate in a water harvesting cycle that includes a water adsorption phase during which water vapor contained in a flow of humid ambient air is adsorbed into a one or more adsorption materials, and a water desorption phase during which adsorbed water vapor is desorbed from the one or more adsorption materials to be condensed in the condensation chamber 3.

The water adsorption/desorption compartment 2 may be lined with a thermally conductive material 20 and may include a plurality of adsorbent material beds 21, each having a one or more water adsorbent material 22. In embodiments of the present disclosure, the thermally conductive material 20 may be configured to transfer heat energy of incoming air flow to the one or more water adsorbent materials 22 contained in the plurality of adsorbent beds 21, thus heating up the one or more water adsorbent materials 22 when such material becomes saturated with water vapor after the water adsorption phase and during the water desorption phase. Such heating effect would result in water vapor desorption, which would be condensed in the condensation compartment 3.

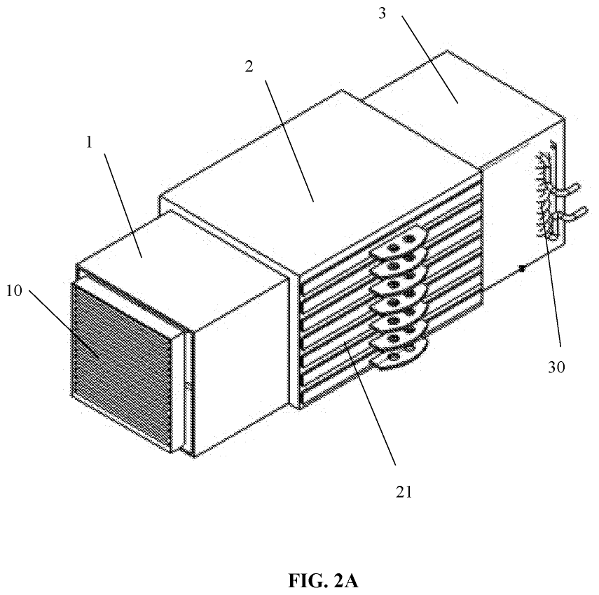

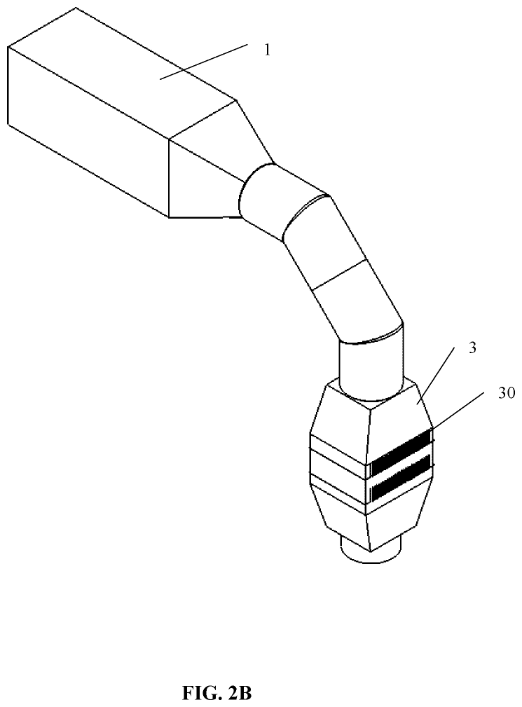

In some embodiments, the plurality of adsorbent material beds 21 may be configured to be oriented horizontally and stacked over each other (FIG. 2A).

In other embodiments, the plurality of adsorbent material beds 21 may be configured to be oriented vertically. In such embodiments, the water adsorption/desorption compartment 2 may be integrated within the air processing compartment 1, and the water collection compartment 4 may be integrated within the condensation compartment 3 (FIGS. 2B, 2C).

In embodiments of the present disclosure, the one or more water adsorbent materials 22 may be configured to adsorb water vapor contained in the air onto, into, or within the pores of such material, and may be selected from a group including metal-organic frameworks, covalent organic frameworks, zeolitic imidazole frameworks, metal catecholates, metal azolates, zeolites, carbon, charcoal, porous rock, silica, porous polymers, porous organic polymers, microporous polymers, polymers, cross-linked polymers, salts, metal oxides, porous cages, clathrates, monoliths, organic molecules, slats, metals, metalloids, or combinations thereof.

In some embodiments, the one or more water adsorption materials 22 may comprise metal-organic framework of the type of MOF-801.

In embodiments of the present disclosure, the atmospheric water generating device of the present disclosure does not need a chemical or a physical water disinfection unit to purify the generated liquid water. This is since the generated liquid water is pure as the adsorbent material has natural disinfection capabilities.

The condensation compartment 3, in embodiments of the present disclosure, may be configured to condense water vapor desorbed from the one or more water adsorbent materials 22. In some embodiments, the condensation compartment 3 may include a finned condenser 30 on which water vapor condenses into water droplets that may be collected via gravitational force by means of a funnel 32 in the water collection compartment 4.

In some embodiments, the condensation compartment 3 may further include a vapor-compression refrigeration unit 31 configured to cool down the finned condenser 30. The vapor-compression refrigeration unit 31 may include a temperature controller 33, a compressor 34 configured to use a refrigerant material to create a temperature gradient between the inside space of the condensation compartment 3 and an external heat exchange unit 35.

In embodiments of the present disclosure, the water collection compartment 4 may include water filtration and mineralization unit 40 configured to purify condensed water and add the required minerals to the generated water before entering the water collection compartment 4. The filtration and mineralization unit 40 has a filter that may be selected from charcoal, carbon, or any other suitable fibrous material.

In some embodiments of the present disclosure, the atmospheric water generator device may work with adaptive mode of operation, the operations inside the device are changeable according to the fluctuations of the climate conditions of the surrounding air, while in other embodiments, the atmospheric water generator device may work with a continuous active mode of operation with a pre-set water harvesting cycle without taking into consideration the fluctuations in climate conditions.

In some embodiments, the air capture compartment 1, the water adsorption compartment 2, and the condensation compartment 3 may be insulated using a suitable heat insulation material, such as, but not limited to, rock wool. Heat insulation would reduce the loss of heat generated by the heating member 12 to the surrounding environment and would reduce the loss of cooling effect generated by the condensation unit 30 to the surrounding environment.

In some embodiments, the atmospheric water generator device of the present disclosure may further include a ventilation mechanism (not shown) that may be configured to allow the air to leave the atmospheric water generator device to the surrounding environment in an open loop configuration.

In embodiments of the present disclosure, the controlling unit 5 may include a plurality of sensors 50 configured to sensing ambient climate conditions, such as, but not limited to ambient air humidity and provide feedback to a controller 51 that is configured to control the operation of the fan 11, the heating member 12, vapor-compression refrigeration unit 31, and optionally the water filtration and mineralization unit 40.

In some embodiments, the plurality of sensors 50 may also be configured to sense the ambient air temperature.

In some embodiments of the present disclosure, the plurality of sensors 50 comprises a humidity sensor.

In some embodiments of the present disclosure, the plurality of sensors 50 further comprises a temperature sensor.

In some embodiments of the present disclosure, the controller 51 may comprise a microcontroller.

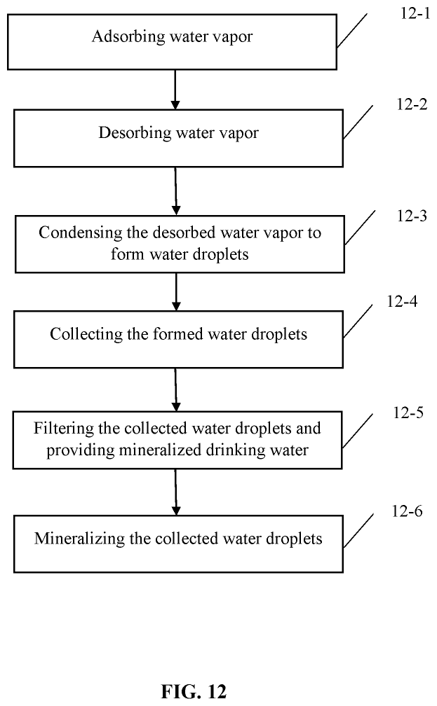

Reference is now being made to FIG. 12, which illustrates a flowchart of a method of generating atmospheric water using the atmospheric water generator described above based on active and adaptive modes of operation, the method may include the steps of adsorbing, by the one or more adsorbent materials, water vapor contained in air flowing over the plurality of adsorbent material beds (process block 12-1); desorbing, once the water adsorbent materials become saturated, the adsorbed water vapor (process block 12-2); condensing, by a condenser, the desorbed water vapor (process block 12-3); collecting the condensed liquid water by a funnel in a water collection compartment (process block 12-4); and filtering, by a water filter, the collected water in the water collection compartment (process block 12-5); and mineralization, by a mineralization unit, the collected water in the water collection compartment (process block 12-6).

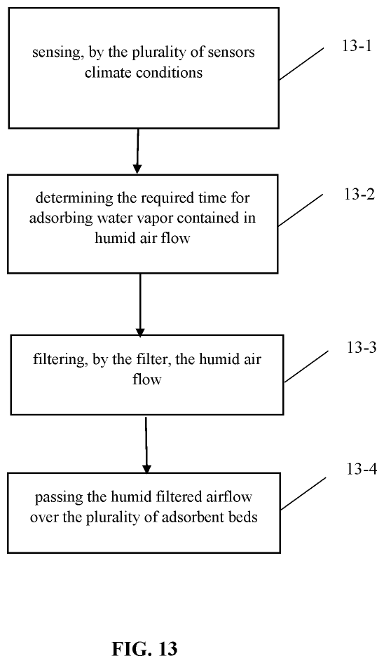

Reference is now being made to FIG. 13, which illustrates a flowchart for the steps of adsorbing water vapor in a method of generating atmospheric water using the atmospheric water generator described above in an adaptive mode of operation, wherein the steps may include sensing, by the plurality of sensors climate conditions (process block 13-1); determining, by the controller, the required time for adsorbing water vapor contained in humid air flow (process block 13-2); filtering, by the filter, the humid air flow (process block 13-3); and passing the humid filtered airflow over the plurality of adsorbent beds (process block 13-4).

In embodiments of the present disclosure, the controller 51 may determine the required time for adsorbing water vapor contained in humid air flow based on the type of one or more adsorption materials used as well as a comparison of humid air flow temperature and/or relative humidity sensed by the plurality of sensors 50 with a pre-defined dataset stored in a database. Such pre-defined dataset may be pre-defined based on optimum efficiency and maximum water productivity depending on the dew point using experimentation, which varies according to the geographical area and in which the device is being utilized and the time of the day, or by using either a trained artificial intelligence algorithm or a mathematical formula.

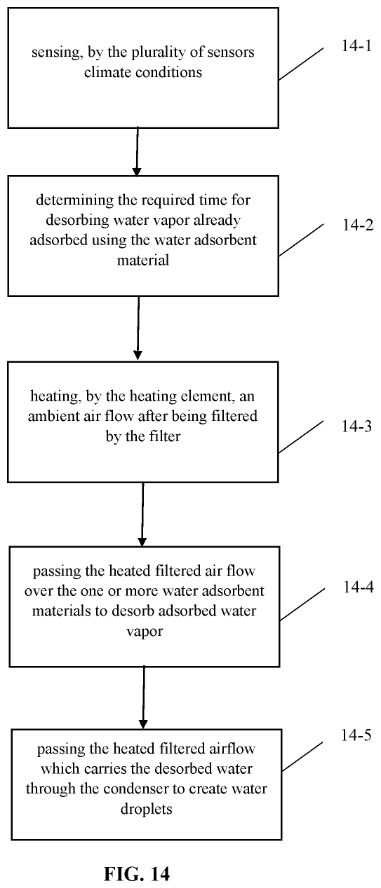

Reference is now being made to FIG. 14, which illustrates a flowchart for the steps of desorbing water vapor in in a method of generating atmospheric water using the atmospheric water generator described above in an adaptive mode of operation, wherein the steps may include sensing, by the plurality of sensors climate conditions (process block 14-1); determining, by the controller, the required time for desorbing water vapor already adsorbed using the water adsorbent material (process block 14-2); heating, by the heating element, an ambient air flow after being filtered by the filter (process block 14-3); passing the heated filtered air flow over the water adsorbent materials to desorb adsorbed water vapor (process block 14-4); and condensing the heated filtered airflow that contains the desorbed water vapor by the condenser as water droplets (process block 14-5).

In embodiments of the present disclosure, the controller 51 may determine the required time for desorbing adsorbed water droplets based on the type of adsorption material used as well as a comparison of humid air flow temperature and relative humidity sensed by the plurality of sensors 50 with a pre-defined dataset stored in a database. Such pre-defined dataset may be pre-defined based on optimum efficiency and maximum water productivity depending on the dew point using experimentation, which varies according to the geographical area and in which the device is being utilized and the time of the day, or by using either a trained artificial intelligence algorithm or a mathematical formula.

The disclosure is now further illustrated on the basis of examples and a detailed description from which further features and advantages may be taken. It is to be noted that the following explanations are presented for the purpose of illustrating and description only; they are not intended to be exhaustive or to limit the disclosure to the precise form disclosed.

### Example 1

### Adaptive Water Adsorption Phase in a Water Harvesting Cycle

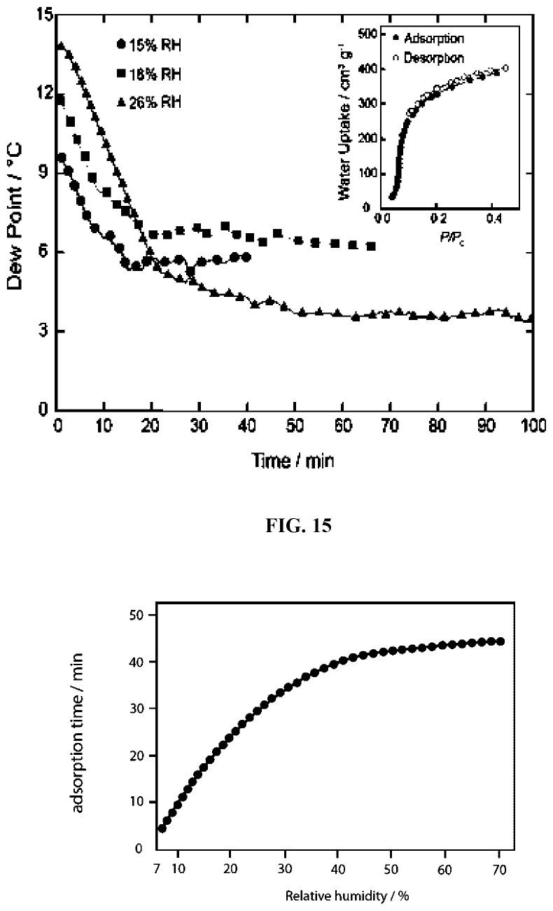

In this example, reference is being made to FIGS. 15-17. The device of the present disclosure was built using about 400 g of metal-organic framework material of the type of MOF-801. A full desorption process was conducted for MOF-801 by forcing hot air at about 80° C. through the water adsorption/desorption compartment for about 2 hours. After this period, MOF-801 was exposed to air at three different relative humidity (“RH”) levels, namely 15, 18, and 26%, and the dew point response at the condensation compartment was recorded. As shown in FIG. 15, the dew point decreases to a steady-state value as a function of time. Given that the difference between the starting and the steady-state dew points reflects the quantity of adsorbed water by the adsorption material, the required timing of the adsorption phase can be elucidated. For example, at 26% RH and 14° C. temperature, the air has an absolute humidity (i.e., actual water quantity in the air) of 11.4 g_{H2O} m⁻³. If the adsorption time is extended to 51 min, a steady-state dew point of 3.4° C. is reached with an absolute humidity of 5.29 g_{H2O} m⁻³, which correlates to 300 g_{H2O} adsorbed within the adsorption material over that time. Reducing the adsorption time to 21 min, which is the start of the steady-state dew point (at 21 min the dew point=5.1° C.), then by the same reasoning, 280 g_{H2O} is adsorbed within the adsorption material. Though this is 7% less quantity of water adsorbed, the timing difference is significant. Furthermore, the start of the steady-state dew points for measurements at 18 and 15% RH were also identified with respect to time (17.5 and 15 min) and quantity of adsorbed water (220 and 180 g_{H2O}), respectively. As the profile of the water sorption isotherm for the adsorption material (FIG. 15 inset) indicates that total uptake saturation occurs at ca. 40% RH, the measured RHs in this experiment provide a satisfactory representation of the material's adsorption performance. From this data, an algorithm was developed to ensure that the adsorption phase of the water harvesting cycle operates using the minimal required adsorption time needed to reach the start of the steady-state dew point at any climate condition according to the following formula:

$$AT = 0.0002 {( RH )}^{3} - 0.0378 {( RH )}^{2} + 2.4714 ( RH ) - 11.257 {R}^{2} = 0.9983$$

wherein
AT is the adsorption time; and
RH is the relative humidity of humid air.

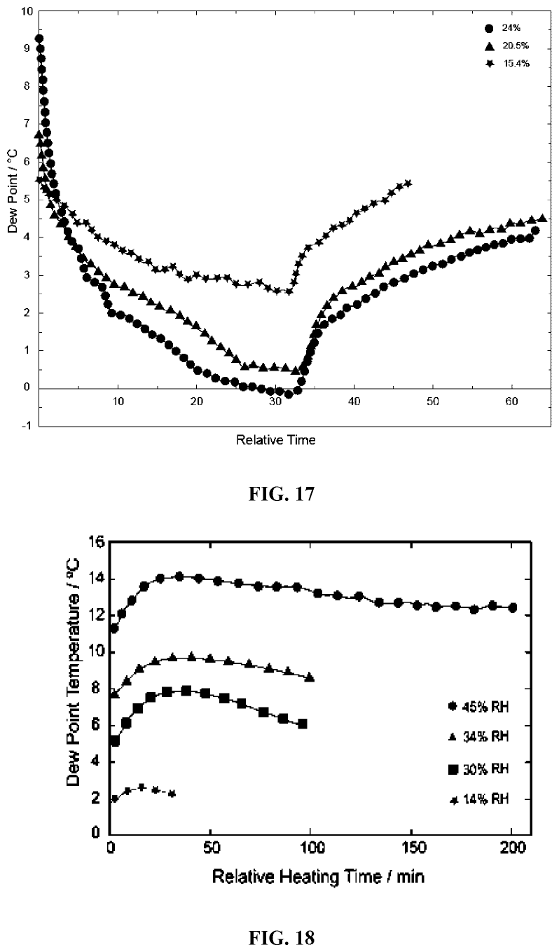

FIG. 16 shows the variation of the desorption time as a function of time in the range of 7-70% RH. The real response at the condensation compartment for the adaptive device is measured for a sample of climate conditions (RH=24.8, 28.4, 30 and 37.2%). The response shown in FIG. 17 was fully consistent with the adaptive adsorption technique, the material was saturated for each condition in the appropriate time.

### Example 2

### Adaptive Water Desorption Phase in a Water Harvesting Cycle

In this example, reference is being made to FIGS. 18-20. The same setup used in Example 1 was also used in this example. In the water desorption phase, the adsorbing material released water vapor from its pores and the dew point of the contained in the device was observed till it reached the maximum. Reaching this maximum ultimately signaled the end of the desorption phase, at which time a gradual decrease was observed until this internal dew point value was equivalent to the external dew point as shown in FIG. 18. The desorption phase was tested at different climate conditions (14, 30, 34, and 45% RH), from which all measurements exhibited the same behavior, but with differing rates of change in dew point. According to the water sorption isotherm of the adsorption material used, 79% of the total uptake capacity is reached by 20% RH. This means that at RH>20%, the timing of the desorption phase is relatively the same, but significantly different at RH<20% (FIG. 18). From these measurements, a second algorithm was developed to correlate heating time to the external climate conditions (i.e., RH) and the power (“W”) of the electric heater employed, as in the following formula:

$$DT = ( 500 / Hp ) ( 0.004 ( {RH}^{3} - 0.0621 {( RH )}^{2} + 3.1302 ( RH ) - 15.625 ) {R}^{2} = 0.9995$$

wherein
DT is the desorption time;
Hp is the horsepower of the heating member; and
RH is the relative humidity.

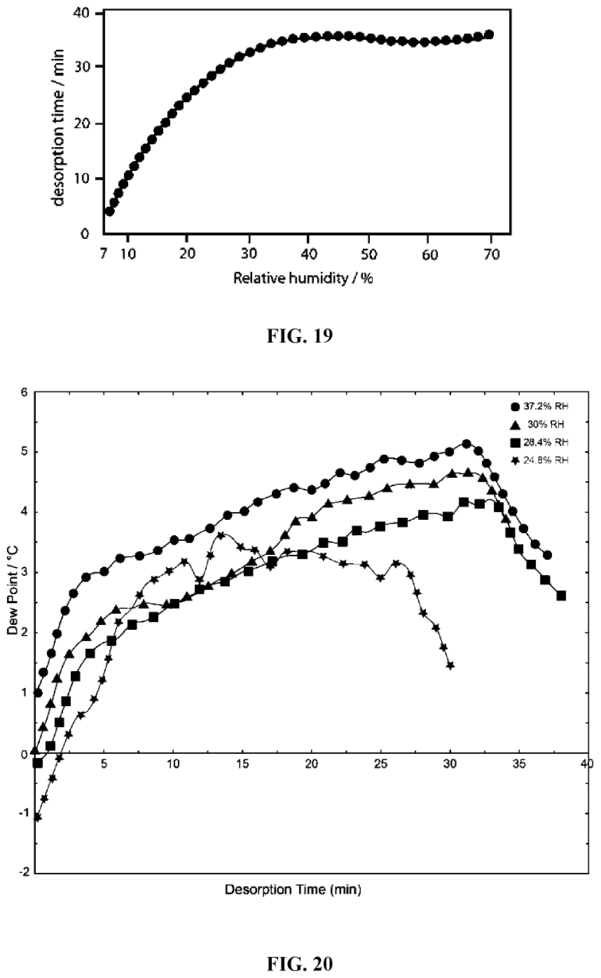

FIG. 19 shows the variation of the desorption time as a function of time in the range of 7-70% RH. A sharp increase in the desorption time was observed at the range of <20% RH, which refers to the higher water uptake observed in the MOF-801 water sorption isotherm. After uploading the adsorption time and the desorption time formulae to the controller, the device operated and the real response at the condensation compartment for the adaptive device is measured for a sample of climate conditions (RH=24.8, 28.4, 30 and 37.2%) with very low dew point temperature (−1.1 C). The response shown in FIG. 20 was fully consistent with the adaptive desorption claim as the adsorbent material was fully desorbed for each condition.

The use of the term “and” in the claims is used to mean “and/or” unless explicitly indicated to refer to collective nature only.

As used herein, the term “adaptive” refers to an operation mode that takes into consideration variable climate conditions and adjusts its operation accordingly in order to produce the maximum amount of output.

As used herein, the term “active” refers to an operation mode that does not take into consideration variable climate conditions and does not adjust its operation accordingly.

While the present disclosure has been made in detail and with reference to specific embodiments, it will be apparent to those skilled in the art that various additions, omissions, or amendments can be made without departing from the scope and spirit thereof.

1-17. (canceled)

18. An atmospheric water generator, comprising:
an air processing compartment comprising a first heating member, a water adsorption/desorption compartment comprising a plurality of water adsorption beds configured to receive an air flow;
a condensation compartment comprising a condenser;
a water collection compartment;
a controlling unit comprising a controller and a plurality of sensors configured to sense climate conditions; and
a power generation and storage unit configured to provide the air processing compartment, the water adsorption/desorption compartment, the condensation compartment, the water collection compartment, and the controlling unit with a required electrical energy to operate,
wherein the first heating member in the air processing compartment is configured to heat the air flow passing through the water adsorption/desorption compartment, and
wherein the climate conditions comprise ambient air temperature and humidity.

19. The atmospheric water generator of claim 18, wherein the air processing compartment further comprises
a fan configured to generate the air flow, and
an air filter configured to remove microorganisms and other solid particulates suspended in the air flow,
wherein the fan is controlled by the controller.

20. The atmospheric water generator of claim 18, wherein the plurality of water adsorption beds is configured to comprise a water adsorbing material.

21. The atmospheric water generator of claim 20, wherein the water adsorbing material comprises a metal-organic framework, covalent organic framework, zeolitic imidazole framework, metal catecholate, metal triazolate, zeolite, carbon, charcoal, porous rock, silica, porous polymer, porous organic polymer, microporous polymer, polymer, cross-linked polymer, salt, metal oxide, porous cage, clathrate, monolith, organic molecule, slat, metal, metalloid, or combination thereof.

22. The atmospheric water generator of claim 18, wherein the water adsorption/desorption compartment is lined with a second heating member configured to transfer heat energy to the plurality of adsorbent beds during a water desorption stage, and
wherein the second heating member is controlled by the controller.

23. The atmospheric water generator of claim 18, wherein the condensation compartment further comprises a funnel configured to collect condensed water droplets under the condenser.

24. The atmospheric water generator of claim 18, wherein the condensation compartment further comprises a vapor-compression refrigeration unit configured to cool down the condenser, and
wherein the vapor-compression refrigeration unit is controlled by the controller.

25. The atmospheric water generator of claim 24, wherein the vapor-compression refrigeration unit comprises a temperature controller, an outdoor heat exchanging unit, and a compressor using a refrigerant to create a temperature gradient between an inside space of the condensation compartment and the outdoor heat exchanging unit.

26. The atmospheric water generator of claim 18, wherein the water collection compartment comprises a water filtration and mineralization unit configured to purify condensed water droplets and add required minerals, and
wherein the water filtration and mineralization unit is controlled by the controller.

27. The atmospheric water generator of claim 26, wherein the water filtration and mineralization unit comprises charcoal, carbon, or another fibrous material.

28. The atmospheric water generator of claim 18, wherein the water adsorption/desorption compartment and the condensation compartment are insulated using a suitable insulation material.

29. The atmospheric water generator of claim 18, wherein the controller is configured to control the operation of the first heating member.

30. A method of generating atmospheric water using the device of claim 18 in an active or adaptive mode of operation, the method comprising:
adsorbing, by one or more water adsorbent materials comprised in a plurality of water adsorption beds, water vapor comprised in air flowing over the plurality of adsorbent material beds;
desorbing, once the one or more water adsorbent materials become saturated, adsorbed water vapor from the one or more water adsorbent materials, to obtain desorbed water vapor;
condensing, by the condenser, the desorbed water vapor into water droplets; and
collecting the water droplets by a funnel in the water collection compartment.

31. The method of claim 30, further comprising:
filtering, by a water filter, collected water in the water collection compartment.

32. The method of claim 31, further comprising:
adding minerals, by a mineralization unit, to the collected water in the water collection compartment.

33. The method of claim 30, wherein adsorbing water vapor in an adaptive mode of operation comprises:
sensing, by the plurality of sensors, the climate conditions;
determining, by the controller, a required time for adsorbing water vapor comprised in a humid air flow;
filtering, by a filter, the humid air flow to obtain a humid filtered airflow; and
passing the humid filtered airflow over the plurality of adsorbent beds.

34. The method of claim 30, wherein desorbing water vapor in an adaptive mode of operation comprises:
sensing, by the plurality of sensors, the climate conditions;
determining, by the controller, a required time for desorbing water vapor already adsorbed using the one or more water adsorbent materials;
heating, by the heating element, an ambient air flow after being filtered by a filter to obtain a heated filtered air flow; and
passing the heated filtered air flow over the one or more water adsorbent materials to desorb adsorbed water vapor.
